(19) United States
(12) Patent Application Publication
(10) Pub. No.: US 2024/0328401 A1
(43) Pub. Date: Oct. 3, 2024

(54) POLYPOSS-POLYIMIDE TWO WAY SHAPE MEMORY POLYMER ACTUATORS

(71) Applicant: Soreq Nuclear Research Center, Yavne (IL)

(72) Inventors: Ronen Verker, Yavne (IL); Yacov Carmiel, Yavne (IL); Avraham Bram, Yavne (IL); Nurit Atar, Yavne (IL); Asaf Bolker, Yavne (IL); Irina Gouzman, Yavne (IL)

(73) Assignee: Soreq Nuclear Research Center, Yavne (IL)

(21) Appl. No.: 18/574,145

(22) PCT Filed: Jul. 26, 2022
(86) PCT No.: PCT/IB2022/056877

§ 371 Date: Dec. 26, 2023

Related U.S. Application Data
(60) Provisional application No. 63/226,783, filed on Jul. 29, 2021.

(51) Int. Cl. F03G 7/06; B32B 3/26; B32B 27/08; B32B 27/28; C08L 79/08; C08L 83/04

(52) U.S. Cl. CPC F03G 7/0612; B32B 3/263; B32B 27/08; B32B 27/281; B32B 27/283; C08L 79/08; C08L 83/04; F03G 7/0616; B32B 2250/02; B32B 2250/24; B32B 2307/30; B32B 2307/54

(57) ABSTRACT

Reversible shape memory polymer bilayer actuators comprised of an active polyPOSS (PP) layer and a passive KAPTON layer. The PP is a unique polymeric composition which maintains its mechanical properties and coefficient of thermal expansion at elevated temperatures while adhering to the KAPTON layer. The actuator is durable to extreme conditions such as elevated temperatures and corrosive environments and maintains motion accuracy at the μm-scale.

### FIELD OF THE INVENTION

The present invention generally relates to reversible shape memory polyPOSS-KAPTON bilayer actuators with highly repeatable motion, fit for operation under extreme conditions such as elevated temperatures or corrosive environments.

### BACKGROUND OF THE INVENTION

The ability of polymers to revert between two shapes has great potential for applications in the fields of robotics, space, and bio-medical engineering. Polymers that can change between two shapes, back and forth, are referred as two-way (or reversible) shape memory polymers (2WSMP). Most of the polymers nowadays that have 2WSMP properties suffer from low mechanical properties and/or low durability in harsh environments.

### SUMMARY OF THE INVENTION

The present invention presents 2WSMP bilayer actuators based on KAPTON (poly (4,4′-oxydiphenylene-pyromellitimide)) and PolyPOSS (PP; POSS stands for polyhedral oligomeric silsesquioxane), two unique advanced polymers that as a bilayer possess 2WSMP properties, superior mechanical properties under bending conditions, extremely high lifting abilities, and durability in harsh environments. KAPTON is well known for its outstanding physical properties under extreme conditions such as ionizing and corrosive environments. PP, a POSS-based epoxy-like thermoset, was developed uniquely for the aforementioned application. PP also presents durability to corrosive environment. Its ability to maintain mechanical properties over a range of temperatures while presenting constant coefficient of thermal expansion is a key role in its use in 2WSMP actuators. Precise control over the bilayers thickness allows precise control over a large range of deflection motion, exerted forces, and mechanical work.

2WSMP actuators can be based on the difference in the coefficient of thermal expansion (CTE) of two materials adhered to each other, similar to bimetal devices. During heating, the layer with higher CTE (active layer) expands more than the passive layer, which leads to the bending of the actuator. The actuators can also be designed to bend in the opposite direction when cooled below ambient temperature. To maximize the bending effect, the CTE difference between the layers should be as high as possible. Often carbon nanotube (CNT) or graphene are used as the passive layers due to their low CTE. Polydimethylsiloxane (PDMS) and various polyolefins are commonly used as the active layer due to their high CTE.

The force generated by a 2WSMP affects its potential application. A common method to normalize and compare the force generated by various 2WSMPs having different dimensions and densities is to divide the measured force by the weight of the sample. Another method is to compare the stress generated by various 2WSMPs.

A 2WSMP made according to the invention lifted 3541 times of its own weight. During this test a 1.1 MPa stress was measured. The actuation blocking stress of this material is 2.53 MPa and it can lift up a load 30,000 times its own weight. For comparison, the actuation stress of a human skeletal muscles is 0.35 MPa.

Prior art 2WSMP actuators lack durability in extreme conditions and have limited lifting ability during bending; they present loss of mechanical properties at an elevated temperature. Furthermore, environmental effects, such as ionizing radiation and corrosive environment, can severely damage prior art polymers used for 2WSMPs by degradation of mechanical properties and etching. In contrast, the unique 2WSMP actuators of the invention have excellent thermal stability, high durability to environmental effects, while maintaining outstanding motion repeatability and extremely high force to weight ratio. The bilayer 2WSMP actuators are based on pristine KAPTON (PK) and polyPOSS (PP), a novel nanocomposite with high durability to extreme conditions.

### BRIEF DESCRIPTION OF THE DRAWINGS

The present invention will be understood and appreciated more fully from the following detailed description taken in conjunction with the in which:

FIG. 1. Temperature-induced shape change of a PP-PK 2WSMP actuator.

FIG. 2. Temperature and deflection vs. time measurements during 10 temperature cycles of the PK125-PP180 actuator.

FIG. 3. Deflection vs. temperature of a PK125-PP180 actuator.

FIG. 4. Maximal deflection of the actuators. The error bars are smaller than ±3 μm.

FIG. 5. Static force produced by the actuators as a function of temperature.

FIG. 6. Static force measurement as a function of PP thickness at 147° C.

FIG. 7. Work values vs. PP layer thickness for the various PK-PP 2WSMP actuators.

FIG. 8. Young's modulus values of KAPTON and PP vs. temperature.

FIG. 9. A single PK125-PP120 actuator lifting a 30 g weight upon heating by an IR source. The white line marks the base level.

FIG. 10. 2WSMP-based engine at work. The cog wheel is rotated by switching the IR source on and off (the numbers mark the order of frames).

FIG. 11. A 2WSMP actuator-driven vehicle movement test (the numbers mark the order of frames).

### DETAILED DESCRIPTION OF EMBODIMENTS

EP0409 Glycidyl POSS was purchased from Hybrid Plastics, USA. Jeffamine D-230 poly(propylene glycol)bis(2-aminopropyl ether) curing agent was purchased from Huntsman, Netherlands. Pristine KAPTON HN polyimide films were purchased from Dupont, USA.

PP is comprised of EP0409 and Jeffamine D-230 preheated to 80° C. and mixed at a 2.8:1 POSS: Jeffamine weight ratio. Pristine KAPTON (PK) films with thickness of 50 μm or 125 μm and dimensions of 2.5 cm×5.5 cm were used as substrates. KAPTON tape was placed on the films to form molds with dimensions of 1.5 cm×4.5 cm, and depth of 60 μm, 120 μm, or 180 μm. The KAPTON molds were treated by air RF plasma cleaner (PDC-3XG, Harrick plasma, USA) for 2 h. The POSS resin was poured into the molds and cured at 100° C. for 1.5 h, followed by post curing at 130° C. for 3 h. After curing, the KAPTON tape was removed, and the film was cut to form actuators with dimensions of 1 cm×2.5 cm. Each actuator was named according to the thicknesses of the PK and PP layer, as described in Table 1.

TABLE 1
List of actuators.

| | | KAPTON | PP thickness |
|---|---|---|---|
| Actuator name | KAPTON type | thickness (μm) | (μm) |
| PK50-PP60 | Pristine (HN) | 50 | 60 |
| PK50-PP120 | Pristine (HN) | 50 | 120 |
| PK50-PP180 | Pristine (HN) | 50 | 180 |
| PK125-PP60 | Pristine (HN) | 125 | 60 |
| PK125-PP120 | Pristine (HN) | 125 | 120 |
| PK125-PP180 | Pristine (HN) | 125 | 180 |

The actuators form a curved shape at RT (room temperature). Heating the actuators caused them to unbend, reaching a fully straight form at 150° C. FIG. 1 shows a PK125-PP180 actuator at both shapes. The upper layer is the PP layer and the lower layer is the KAPTON layer.

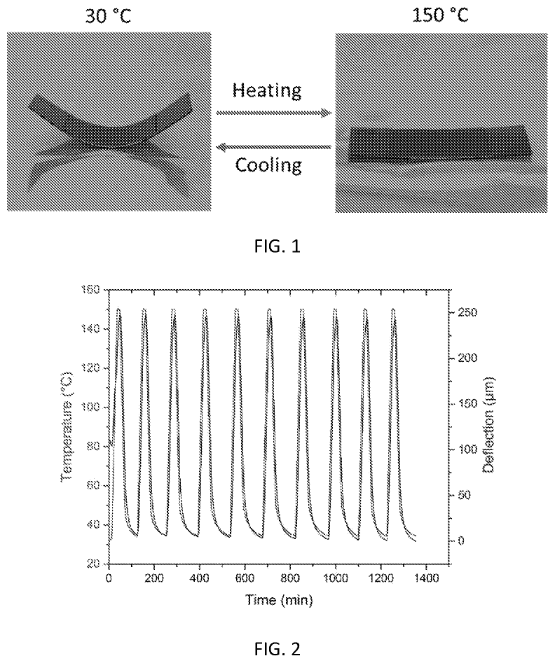

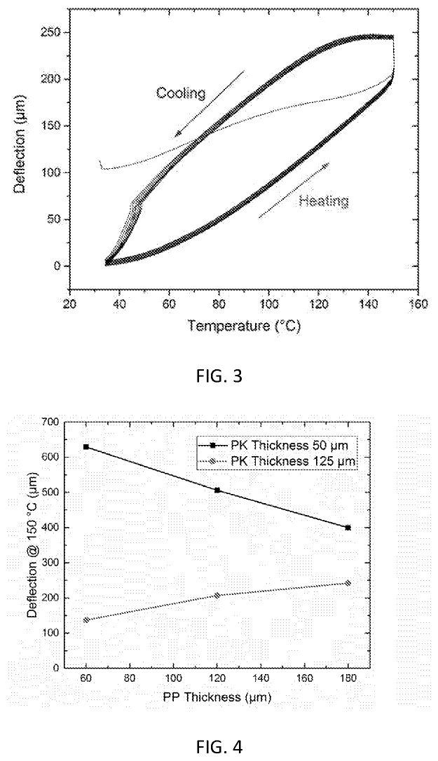

The actuators deflection during thermal cycles was measured by dynamic mechanical analyzer (DMA) using a 3-point bending fixture with a 5 mm support span. To visualize the repeatability of the deflection measurements, FIG. 2 shows the results of the deflection measurements during 10 temperature cycles, from 30 to 150° C., of a PK125-PP180 actuator. The same data is plotted as a temperature-deflection graph in FIG. 3 to demonstrate the repeatability of the actuator movement. During the heating cycles, the line width of FIG. 3 (which represents the change in deflection from cycle to cycle) was 5.6 μm at 40° C., over an average normalized deflection of 242 μm. FIG. 4 presents the maximal deflection vs. the thickness of the PP layer that was received when the various actuators' temperature reached 150° C. The maximal deflection was measured for the PK50-PP60 actuator, 630 μm, while the smallest deflection was measured for the PK125-PP60 actuator, 140 μm. For actuators having PK thickness of either 50 μm or 125 μm, as the thickness of the PP layer was increased the trend of the deflection values tend toward convergence. For PP thickness of 180 μm the deflection of actuators with PK thickness of 50 μm decrease from 630 to 400 μm while for the actuators with PK thickness of 125 μm the deflection increased from 140 to 240 μm. For a given PK thickness and temperature the governing parameter for determining the deflection is the PP thickness.

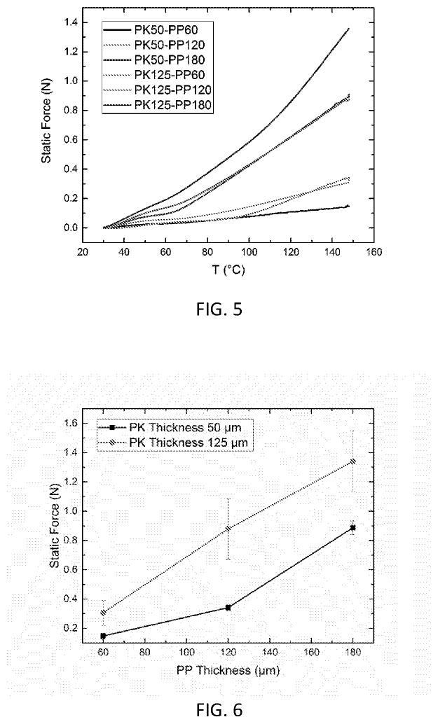

FIG. 5 presents the static force produced by the 2WSMP actuators at a given temperature. The general trend of the increase of the static force, as a function of the temperature, is almost linear for most of the actuators. For some of the actuators the increase in the static force can be divided into two parts; a slow increase up to a temperature of 70-90° C. following by a fast increase up to 150° C. PK50-PP60 produced the smallest static force values while PK125-PP180 produced the highest values. In general, it can be noticed that the governing parameter which determines the generated static force is the thickness of the PP layer. PK50-PP180 and PK125-PP120 presents a resemblance in the static force measurements, and so does PK50-PP120 and PK125-PP60. These results exemplify a tradeoff between the thickness of the passive PK layer and the thickness of the active PP layer. That is, when the PP layer thickness was reduced by 60 μm the same static force was generated by the bilayer actuator if the thickness of PK layer was increased by 75 μm.

FIG. 6 presents the static force measurements generated by the actuators at 147° C. vs. the actuator type i.e. the layers' thickness. An almost linear relationship can be noticed between the static force and the PP layer thickness for a given PK layer thickness. The highest static force values were measured for the PK50-PP180 and PK125-PP180 actuators, intermediate static force values were measured for the PK50-PP120 and PK125-PP120 actuators, and the smallest values were measured for the PK50-PP60 and PK125-PP60 actuators. The 2WSMP bilayer actuators can produce static forces as high as 0.9 N in the case of PK50-PP180 and 1.3 N in the case of PK125-PP180 at a temperature of 147° C. The force measurement was conducted on a 5 mm span. The average weight of the PK50-PP180 and PK125-PP180 actuators is 14.6 mg for the PK50-PP180 actuator, and 19.9 mg for the PK125-PP180 actuator. This leads to an effective force to weight ratios of 61:1 and 65:1 N/g, respectively.

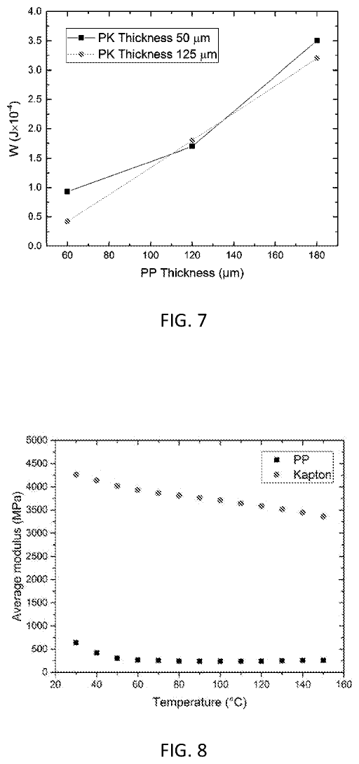

The work (W) of the various 2WSMP actuators was calculated according to equation 1:

$$W = F \times D \qquad ( 1 )$$

where F is the static force and D is the deflection. FIG. 7 presents the work values vs. the PP layer thickness for the various PK-PP 2WSMP actuators. The work attained by the actuators with a PK thickness of 125 μm increases linearly with the PP layer thickness. For the actuators with PK thickness of 50 μm the attained work values increase almost linearly as the PP layer thickness was increased, although at the same time the deflection monotonically decrease, as seen in FIG. 4. The work depends solely on the PP layer thickness, as it increases the work increases too, either due to an increase in the deflection or as a result of an increase in the static force. In case of a decrease in one of the two, as in the case of the decrease in the deflection shown in FIG. 4, the other parameter compensate for this decrease and the end result is a monotonic increase in the product of the deflection and force.

The ability of the 2WSMP actuators to apply the above forces as the shape memory effect take place arise from the ability of the PK and PP layers to maintain high young modulus values at a wide temperature range, from room temperature up to 150° C. The average modulus values vs. temperature are presented in FIG. 8. As shown, the KAPTON modulus decreased almost linearly from ˜4250 MPa at 30° C. to ˜3360 MPa at 150° C. The PP modulus first decreased from ˜640 MPa at 30° C. to ˜270 MPa when heated to 60° C., and then remained almost constant at 250 MPa, upon further heating to 150° C.

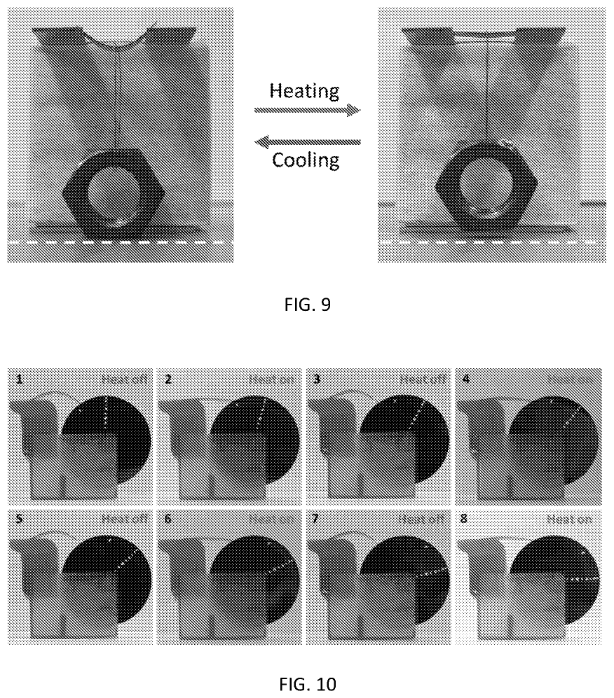

To demonstrate the force a single actuator can apply, a PK125-PP120 actuator weighing 0.07 g was placed on a 16 mm support span. A steel nut weighing 30 g was attached to the actuator, as illustrated in FIG. 9. When heated by an IR source, the actuator straightened and pulled the weight up, thus lifting a weight 428 times of its own.

To translate the bending motion into a circular motion, a 2WSMP-based engine was designed. The engine is based on a cogwheel being turned when pushed by the shape change of an actuator. The cogwheel was cut form a 125 μm thick KAPTON film, and the engine body was assembled from BMI 3D-printed parts.

The engine was operated by turning the IR source on and off. When on, the heated actuator straightened, pushing the cogwheel clockwise. When the IR source was turned off, the actuator was cooled down and retracted. A KAPTON stopper at the base of the cogwheel prevented it from turning counterclockwise. With every cycle of heating/cooling, the wheel was turned by several degrees. FIG. 10 shows the engine during several cycles of operation. The images show the actuator at both cooled and heated states, and the white dots visualize the cog wheel rotation.

After experimenting with the 2WSMP-based engine, a miniature vehicle powered by a 2WSMP actuator was built. The vehicle is composed of a front cogwheel, like the one used in the engine but smaller in diameter, and two back wheels. The vehicle chassis was prepared from 3D printed BMI. A 2WSMP actuator was placed with one end between the back wheels, and the other on the cogwheel. A KAPTON stopper was placed on the ramp behind the cogwheel to prevent the cogwheel from turning in the opposite direction.

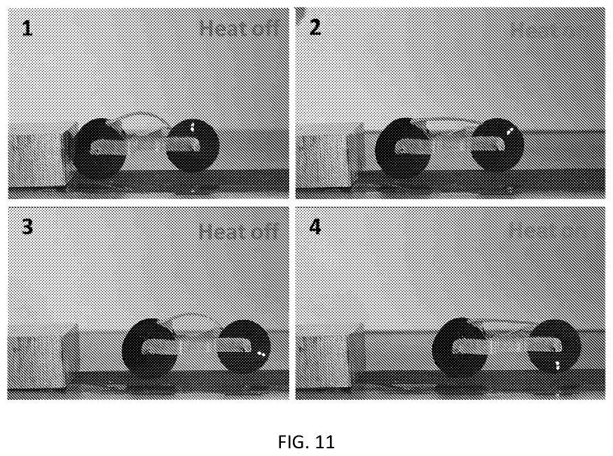

For the motion test, an IR source was turned on and off sequentially causing the actuator to straighten and bend, thus turning the cogwheel and moving the vehicle forward. The test was stopped after the front wheel completed half of a cycle, which corresponded to planar movement of 3 cm. A summary of the movement test is presented in FIG. 11.

What is claimed is:

1. An actuator comprising:
a two-way shape memory polymer (2WSMP) bilayer actuator comprising a thermally activated poly-(polyhedral oligomeric silsesquioxane) (PP) layer and a passive poly-(4,4′-oxydiphenylene-pyromellitimide) (PK) layer.

2. The actuator according to claim 1, wherein said PP layer adheres to said PK layer while performing repeatable motions at elevated temperatures as high as 150° C.

3. The actuator according to claim 1, wherein said PP layer maintains a constant coefficient of thermal expansion value from room temperature up to 150° C.

4. The actuator according to claim 1, wherein said PP layer maintains Young's modulus values above 250 MPa at temperatures as high as 150° C.

5. The actuator according to claim 1, wherein said 2WSMP actuator is capable of repeatable motion at temperatures as high as 150° C.

6. The actuator according to claim 1, wherein bending deformation and strain of said 2WSMP bilayer actuator is controlled by varying a thickness ratio of the PP and PK layers.

7. The actuator according to claim 1, wherein a stress and a force applied by said 2WSMP bilayer actuator is controlled by varying a thickness ratio of the PP and PK layers.
